(19) United States
(12) Patent Application Publication
(10) Pub. No.: US 2025/0236297 A1
(43) Pub. Date: Jul. 24, 2025

(54) Method and Device for Controlling the Lateral Control of a Motor Vehicle

(71) Applicant: Bayerische Motoren Werke Aktiengesellschaft, Muenchen (DE)

(72) Inventors: Martin GERWALLNER, Muenchen (DE); Kevin MEYER, Muenchen (DE); Joeran ZEISLER, Muenchen (DE)

(21) Appl. No.: 18/880,941

(22) PCT Filed: Jun. 30, 2023
(86) PCT No.: PCT/EP2023/067956

§ 371 Date: Jan. 3, 2025

(30) Foreign Application Priority Data
Jul. 4, 2022 (DE) 10 2022 116 643.0

(51) Int. Cl. B60W 30/165; B60W 30/12

(52) U.S. Cl. CPC B60W 30/165; B60W 30/12; B60W 2552/53; B60W 2554/4041; B60W 2554/4044; B60W 2554/802

(57) ABSTRACT

A method for controlling the lateral control of a motor vehicle includes determining the occurrence of a first predetermined driving situation in which the motor vehicle is in an idle position and a distance between the motor vehicle and a vehicle in front increases, detecting a trajectory of the vehicle in front when the occurrence of the first predetermined driving situation is determined, detecting the occurrence of a second predetermined driving situation which follows the first predetermined driving situation and in which the motor vehicle moves from the idle position, and controlling the lateral control of the motor vehicle on the basis of the detected trajectory when the occurrence of the second predetermined driving situation is determined.

### BACKGROUND AND SUMMARY

The present disclosure relates to a method for controlling the lateral control of a motor vehicle and a data processing device designed to at least partially carry out the method. Furthermore, an optionally automated motor vehicle having the data processing device is provided. Additionally or alternatively, a computer program is provided comprising commands which, upon the execution of the program by a computer, prompt it to at least partially carry out the method. Additionally or alternatively, a computer-readable medium is provided comprising commands which, upon the execution of the commands by a computer, prompt it to at least partially carry out the method.

Driver assistance systems assist a driver of a (motor) vehicle by way of notifications on the current traffic situation and/or by way of situational and/or continuous interventions in the longitudinal control and/or lateral control of the motor vehicle.

However, situations can occur during the automated lateral control in semiautomated systems in road traffic which cannot be managed by the driver assistance system for automated lateral control. It is known that the steering system will attempt to follow previously detected roadway markings. In the case of roadway markings or lane information which are not sufficiently recognized or are absent, the steering system can temporarily follow a front vehicle in order to increase the availability of the automated lateral control. This so-called following driving of the lateral control can only be maintained, however, if the front vehicle does not exceed a maximum distance to the ego vehicle. The typical known technical implementation during following driving provides a type of storage and driving along waypoints from the observation of the vehicle positions of the front vehicle in relation to the ego vehicle in this case. By cyclically scanning the position and alignment of the front vehicle, reference trajectory can be generated which the ego vehicle follows in the scope of its technical-physical and normative guidelines. A trajectory is to be understood here as the path and optionally the speed profile of the vehicle. For driving maneuvers that can be expected in public road traffic on public roads, this method is a routine implementation in order to maintain the lateral control of the partial automation in areas, in which adequate roadway markings or lane information do not exist or cannot be detected, by a sensor using the presence of the leading vehicle.

US 2020/0051436 A1 discloses in this context, for example, a method for controlling a vehicle straight ahead through an intersection, wherein a lane determination unit is provided which takes into consideration various information such as position information of the lane markings and road ends, as well as position and movement of a leading vehicle, in order to determine whether a lane of the vehicle corresponds with the available map information. When a recognition unit recognizes a leading vehicle, following driving can take place.

Due to the known restrictions that the front vehicle has to be present during the actual journey, however, availability restrictions arise in situations in which the journey of the ego vehicle is interrupted. Such a situation can exist, for example, when the ego vehicle stops in the first position at a red traffic signal, or a stop has to take place for another reason due to traffic. The front vehicle passes the traffic signal as it turns red in such a situation as the last road user, for example, and the ego vehicle is the first vehicle that subsequently drives into the intersection after passing the cross traffic. Similar problems can also occur at roadway crossings and in the case of further regulation-related stopping operations.

US 2018/0148052 A1 discloses in this context, for example, a method in which a virtual lane marking is generated on the basis of a first end node of a lane marking in a road section on an entry side and a second end node of a lane marking is generated in a road section on an exit side.

DE 10 2020 102 717 A1 discloses in this context a method for controlling a vehicle across an intersection, which is based on receiving intersection data transmitted from an infrastructure associated with the intersection.

The above-mentioned method from the prior art requires the presence of map information about the intersection or about the area having the inadequately recognized or absent roadway markings, however.

A technical problem can occur in particular in vehicles having a lack of high accuracy map information, so that a possible lane across the intersection or said area cannot be obtained from map information.

Against the background of this prior art, an object of the present disclosure is to specify a method capable of meeting at least the above-mentioned requirement and enabling an adaptation of the control of the motor vehicle.

This object is achieved by the features disclosed herein. The present disclosure also includes optional refinements.

Accordingly, this object is achieved by a method for controlling the lateral control of a motor vehicle.

The method can be designated in particular as a method for controlling the lateral control of a motor vehicle by way of at least one front vehicle trajectory.

The method can be a computer-implemented method, i.e. one, multiple, or all steps of the method can be at least partially carried out by a computer or a device for data processing.

Moreover, the method is not limited to the control of the lateral control of the motor vehicle and it is also conceivable that the longitudinal control of the motor vehicle is controlled analogously to the lateral control.

The method comprises establishing a presence of a first predetermined driving situation in which the motor vehicle is in an idle position and a distance between the motor vehicle and a leading vehicle increases.

An idle position can be understood as a state of the motor vehicle in which it has a low speed of less than 30 km/h, in particular less than 10 km/h, or essentially 0 km/h, which can also be referred to as a standstill. Such a driving situation can occur, for example, at an intersection, a railway crossing, and/or a toll station. However, the interpretation of the term idle position is not restricted thereto and can also relate to a relative speed of the motor vehicle to the leading vehicle, wherein the speed of the leading vehicle is greater than that of the motor vehicle, so that the leading vehicle moves away from the motor vehicle. This can be the case on a freeway, for example.

Establishing that the leading vehicle or the front vehicle moves away from the motor vehicle can be carried out, for example, by sensor data of a sensor system of the motor vehicle, optionally comprising a camera, a radar sensor, a LiDAR sensor, and/or an ultrasonic sensor.

The method comprises detecting a trajectory of the front vehicle when the presence of the first predetermined driving situation is established.

The above described sensor system of the motor vehicle can also be used for this purpose. A trajectory can be understood as position information, optionally together with time information; i.e. along which path or way the front vehicle has moved away, optionally paired with information about when the front vehicle has been located at which position along this path. The latter offers the advantage that information about a speed and/or acceleration of the front vehicle can also be taken into consideration in the longitudinal control of the motor vehicle, provided it is controlled by the method.

The method comprises detecting a presence of a second predetermined driving situation, which chronologically follows the first predetermined driving situation and in which the motor vehicle drives off from the idle position.

The above-described sensor system of the motor vehicle can also be used for this purpose.

The driving off of the motor vehicle from the idle position can be understood as a positive acceleration of the motor vehicle in which the above-described low speed is exceeded.

The method comprises controlling the lateral control of the motor vehicle based on the detected trajectory when the presence of the second predetermined driving situation is established.

The control of the lateral control can comprise passive and/or active control of the lateral control, wherein passive control of the lateral control can be understood as assisting the driver of the motor vehicle during the lateral control, e.g., by visual, tactile, and/or auditory information, whereas active control of the lateral control of the motor vehicle can be understood as an active steering intervention in a steering system of the motor vehicle, by which a direction of travel of the motor vehicle is changeable or is defined.

It is conceivable that surroundings information, such as obstacle recognition, is also taken into consideration in the control of the lateral control of the motor vehicle.

Possible refinements of the above method are explained in detail hereinafter.

The detection of the trajectory of the front vehicle can take place until the distance between the motor vehicle and the front vehicle exceeds a threshold value, in particular as long as the front vehicle can be detected by the sensors of the motor vehicle in sufficient quality.

The control of the lateral control of the motor vehicle can take place based on the detected trajectory so that the motor vehicle follows the detected trajectory.

The control of the lateral control of the motor vehicle can take place based on the detected trajectory only as long as no lane marking and/or no front vehicle are present in an area of predetermined size in front of the motor vehicle.

The control of the lateral control of the motor vehicle can take place based on a lane marking and/or a current trajectory of the front vehicle as soon as the lane marking and/or the front vehicle are present in the area of predetermined size in front of the motor vehicle.

The method can comprise determining a planned route of the motor vehicle and comparing the planned route of the motor vehicle to the detected trajectory. The control of the lateral control of the motor vehicle can take place based on the detected trajectory only or exclusively when the comparison has the result that the planned route of the motor vehicle and the detected trajectory correspond, in particular at least to a predetermined degree.

The detected trajectory can comprise position information, optionally with time information, of the front vehicle.

The description above can be summarized in other words and with respect to a possible more specific implementation of the disclosure as follows, wherein the following summary is described as not restrictive for the disclosure: An availability increase of the automated lateral control by using historic front vehicle trajectories is proposed. Driver assistance systems can assist the driver by notifications on the current traffic situation as well as situational or continuous interventions in the longitudinal and lateral control of the ego vehicle. If longitudinal and/or lateral control are taken over permanently, the system can be designated as a semiautomated system of SAE level 1 (one component) or 2 (both components). At these automation levels, the driver always remains responsible for monitoring the system and has to be ready to take over, essentially immediately. A background of this involvement can be a lack of ability to control the possible situations in the road traffic by way of the steering system. This is known to attempt to follow the previously detected lanes or lane markings. It can temporarily follow the front vehicle in the event of marking elements which are inadequately recognized or absent on the road, in order to increase the availability of the driver assistance system. This following driving of the lateral control can only be maintained when the front vehicle has a sufficient distance to the ego vehicle. The known technical implementation follows a type of storage and driving along waypoints from the observation of the vehicle positions of the front vehicle in relation to the ego vehicle here. By cyclically scanning the position and alignment of the front vehicle, a reference trajectory can be generated which the ego vehicle follows in the context of is technical-physical and normative guidelines. For the driving maneuvers that can be expected in public road traffic on public roads, this method is a routine implementation for maintaining the lateral control while lane information is absent. In particular in areas in which adequate markings or lane features do not exist or are not sensed, the lateral control of the partial automation can be maintained with the presence of the front vehicle. Due to the known restrictions that the front vehicle has to be present during the actual journey, availability restrictions occur in situations in which the journey of the ego vehicle is interrupted. For example, when a stop has to take place in the first position at a red traffic signal or due to traffic for another reason. The front vehicle passes the traffic signal as it turns red as the last road user, for example, and the ego vehicle is the first vehicle which subsequently drives into the intersection after passing the cross traffic. Similar problems can also occur at railway crossings and further regulation-related stopping operations. The disclosure therefore predominantly relates to intersections and railway crossings, but is not limited thereby. In order to still be able to offer semiautomated lateral control in corresponding (driving) situations (referred to above as the first driving situation), in which sufficient lane information is not available and the distance to the front vehicle becomes too great, the trajectory of the previously applicable front vehicle which is moving away is to be stored. After the ego vehicle drives off again (referred to above as the second driving situation), it is used as the target variable for the lateral control. The technical problem can occur in particular in vehicles with a lack of high-accuracy map information, so that a possible lane across the intersection cannot be obtained from this map information. The ego vehicle then repeats the lateral movements of the front vehicle including required lane offsets or invasion maneuvers to reach the target lane after the intersection. In consideration of all guidelines, this has the result that the automated steering of the ego vehicle upon driving off again would be identical to the automated steering which would be expectable by the front vehicle upon direct following without a stop. Since the errors of the sensory position and orientation determination increase with increasing distance between ego vehicle and front vehicle, the proposed technical implementation of the use of historic front vehicle trajectories can only take place up to a certain distance. In the ideal case, after traversing the region with absent lane markings, corresponding boundaries are detectable again and are subsequently used again as the input variable for determining the lateral control. If corresponding information is absent and it is also no longer possible to keep up with the front vehicle, the deactivation of the lateral control is not to be excluded. A plausibility check that the trajectory of the actual front vehicle is maintained even when further, for example, crossing vehicles are observed, can take place. Additionally or alternatively, a plausibility check can take place that one or more rough target specifications of the ego vehicle (navigation route, turn signal, direction of the lane) correspond to the detected trajectory. Furthermore, it is conceivable that a minimal approach is followed which discards a history of the trajectory in the case of available sensor data. Specifically, the description above can then be used in a situation in which the driver of the ego vehicle drives toward a traffic signal intersection in assisted level 1 or 2 operation with active lateral control and the ego vehicle stops as the first vehicle at the traffic signal as it turns red. The vehicle driving in front of him traverses the intersection as the last before the cross traffic begins. After the traffic signal becomes green again, the ego vehicle continues, with active lateral control again, the journey across the intersection, on which otherwise no lateral control would be available, since corresponding markings are absent and follows the trajectory of the vehicle here which has passed the traffic signal as the last one before him. The previously observed trajectory of the front vehicle describes an S shape due to the slightly offset alignment of the road, which apparently leads straight ahead, which the ego vehicle follows and at the same time maneuvers across the intersection in a manner which is comprehensible to the driver and accurate. In the target road, the available lane is taken in the center between parking vehicles and oncoming traffic.

Furthermore, a computer program is provided, comprising commands which, upon execution of the program by a computer, prompt it to at least partially execute or carry out the above-described method.

A program code of the computer program can be provided in any arbitrary code, in particular in a code which is suitable for controllers of motor vehicles.

The description above with reference to the method also applies analogously to the computer program and vice versa.

Furthermore, a data processing device, such as a control unit, for an automated motor vehicle is provided, wherein the control unit is configured to at least partially execute or carry out the above-described method. The method is therefore a computer-implemented method.

The data processing device can be part of a driver assistance system or can represent it. The data processing device can be, for example, an electronic control unit (ECU). The electronic control unit can be an intelligent processor-controlled unit which can communicate, for example, via a central gateway (CGW) with other modules and which can possibly form the vehicle onboard network via field buses, such as the CAN bus, LIN bus, MOST bus, and FlexRay or via automotive ethernet, for example, together with telematics control units. It is conceivable that the control unit controls functions relevant for the driving behavior of the motor vehicle, such as the motor control, the force transmission, the braking system, and/or the tire pressure monitoring system. In addition, driver assistance systems, such as a parking assistant, an adaptive cruise control (ACC), a lane keeping assistant, a lane changing assistant, a traffic sign recognition function, a light signal recognition function, a starting assistant, a night vision assistant and/or an intersection assistant can be controlled by the control unit.

The description above with respect to the method and the computer program also applies analogously to the data processing device and vice versa.

Furthermore, a motor vehicle comprising the above-describe data processing device is provided.

The motor vehicle can be a passenger vehicle, in particular an automobile, or a utility vehicle, such as a truck. The motor vehicle can be designed to at least partially and/or at least temporarily take over the longitudinal control and/or the lateral control during automated driving of the motor vehicle. Automated driving can take place so that the forward movement of the motor vehicle takes place (substantially) autonomously. The automated driving can be controlled at least partially and/or temporarily by the data processing device.

The motor vehicle can be a motor vehicle of autonomy level 0, i.e. the driver takes over the dynamic driving task, even if assisting systems (such as ABS or ESP) are present.

The motor vehicle can be a motor vehicle of autonomy level 1, i.e. can have specific driver assistance systems which assist the driver in the vehicle operation, such as the adaptive cruise control (ACC).

The motor vehicle can be a motor vehicle of autonomy level 2, i.e. partially automated so that functions such as automatic parking, lane keeping or lateral guidance, general longitudinal guidance, acceleration, and/or deceleration can at least partially be taken over by driver assistance systems.

The motor vehicle can be a motor vehicle of autonomy level 3, i.e. conditionally automated so that the driver does not have to continuously monitor the system of the motor vehicle. The motor vehicle independently carries out functions such as triggering the turn signal, lane changing, and/or lane keeping. The driver can address other things but will be prompted by the system if needed within a prewarning time to take over the control.

The motor vehicle can be a motor vehicle of autonomy level 4, i.e. so highly automated that the guidance of the vehicle is permanently taken over by the system of the vehicle. If the driving tasks are no longer managed by the system, the driver can be prompted to take over the guidance.

The motor vehicle can be a motor vehicle of autonomy level 5, i.e. so fully automated that the driver is not necessary to fulfill the driving task. Except for defining the destination and starting the system, no human intervention is necessary. The motor vehicle can manage without steering wheel and pedals.

The description above with reference to the method, the data processing device, and the computer program also applies analogously to the motor vehicle and vice versa.

Furthermore, a computer-readable medium is provided, in particular a computer-readable storage medium. The computer-readable medium comprises commands which, upon the execution of the program by a computer, prompt it to at least partially execute the above-described method.

That is to say, a computer-readable medium can be provided which comprises an above-described computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be externally acquired via the Internet or in another way.

The description above with reference to the method, the data processing device, the computer program, and the automated motor vehicle also applies analogously to the computer-readable medium and vice versa.

An embodiment is described hereinafter with reference to FIGS. 1 and 2.

### BRIEF DESCRIPTION OF THE DRAWINGS

FIG. 1 shows a schematic flow chart of a method for controlling the lateral control of a motor vehicle, and

FIG. 2 schematically shows by way of example two driving situations in which the method is used.

### DETAILED DESCRIPTION OF THE DRAWINGS

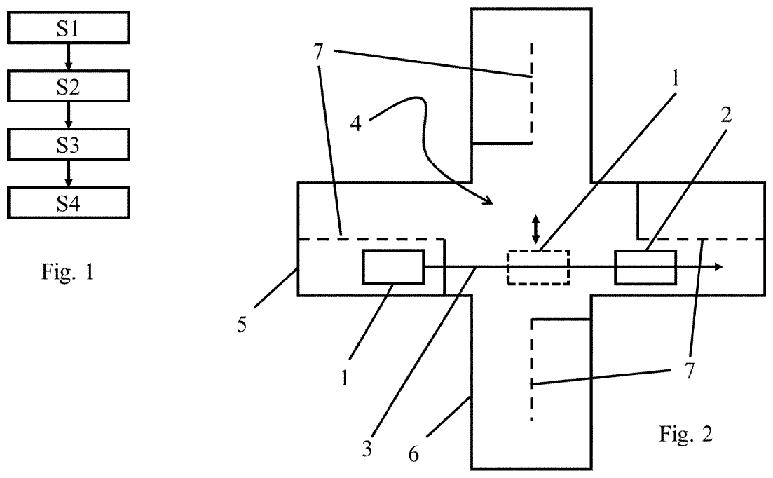

The method for controlling the lateral control of a motor vehicle 1 essentially has four steps S1-S4, as can be seen from FIG. 1, and will be explained in detail according to the above-described embodiment with reference to a scenario shown in FIG. 2.

FIG. 2 shows an intersection 4 from the bird's eye perspective, at which two roads 5, 6 intersect, wherein the intersection 4 itself does not have any road or lane markings 7. In a first driving situation, a motor vehicle 1, which executes the method, stops at the intersection 4 and a leading vehicle 2 traverses the intersection 4 along a trajectory 3.

In a first step S1 of the method, it is established by the motor vehicle 1, which can also be referred to as the ego vehicle, that the first driving situation is present, i.e. that a first predetermined driving situation is present in which the motor vehicle 1 is in an idle position and a distance between the motor vehicle 1 and a front vehicle 2 increases.

In a second step S2 of the method, the trajectory 3 of the front vehicle 2 is detected by the motor vehicle 1, since the presence of the first predetermined driving situation was established in first step S1. The recorded trajectory 3 comprises position information and time information of the front vehicle 2 in the present case. That is to say, a path of the front vehicle 2, along which it drives across the intersection 4, and a speed of the front vehicle 2 along this path is recorded by the motor vehicle 1 from the idle position (in this position the motor vehicle 1 is shown by solid lines) by a sensor system of the motor vehicle 1. The detection of the trajectory of the front vehicle 2 continues to take place until the distance between the motor vehicle 1 and the front vehicle 2 exceeds a predetermined threshold value. This can depend on a performance of the sensor system of the motor vehicle 1.

After the front vehicle 2 has passed the intersection 4, crossing traffic begins, as indicated in FIG. 2 by the double arrow.

After the crossing traffic has passed the intersection 4, in a third step S3 of the method, a presence of a second predetermined driving situation is detected, which chronologically follows the first predetermined driving situation and in which the motor vehicle 1 drives off from the idle position (shown by dashed lines in FIG. 2). The method can also comprise a step of automated driving off of the motor vehicle 1 here.

In a fourth step S4 of the method, since the presence of the second predetermined driving situation was established in third step S3, i.e. as soon as the motor vehicle 1 drives off, a control of the longitudinal and lateral control of the motor vehicle 1 can take place based on the detected trajectory 3. For this purpose, a planned route of the motor vehicle 1 is initially determined and it is compared whether the trajectory 3 extends along the planned route of the motor vehicle 1. The motor vehicle 1 drives straight ahead across the intersection 4 according to its planned route, so that the trajectory 3 extends along the planned route of the motor vehicle 1. The control of the lateral control of the motor vehicle 1 therefore takes place based on the detected trajectory 3 so that the motor vehicle 1 follows the detected trajectory 3. This takes place only or exclusively because the comparison of planned route and trajectory 3 has had the result that they correspond. Otherwise, thus, for example, if the motor vehicle 1 had turned off into the road 6 according to its planned route, the motor vehicle 1 would not have followed the trajectory 3. The lateral control would have been carried out manually by the driver of the motor vehicle 1. The control of the lateral control of the motor vehicle 1 based on the detected trajectory 3 only takes place here as long as no lane marking and/or no front vehicle are present in an area of predetermined size in front of the motor vehicle 1. As soon as the motor vehicle 1 has passed the intersection 4 in the present case, the control of the lateral control of the motor vehicle 1 (again) takes place based on the lane marking 7 (and/or a current trajectory of a front vehicle). This also applies to the control of the longitudinal control of the motor vehicle 1, which also takes place on the basis of the recorded trajectory 3, more precisely on the basis of the speed of the front vehicle 2 along the trajectory 3.

It is therefore possible using the above-described method to at least control in an automated manner the lateral control of the motor vehicle 1 in an area in which the motor vehicle 1 cannot orient itself to a currently leading vehicle or to lane markings 7. This increases an availability of a lateral control system of the motor vehicle 1.

### LIST OF REFERENCE SIGNS

1 motor vehicle or ego vehicle
2 front vehicle
3 historic trajectory of the front vehicle
4 intersection
5 road
6 road
7 roadway marking
S1-S4 method steps

1-10. (canceled)

11. A method for controlling lateral control of a motor vehicle comprising:
establishing a presence of a first predetermined driving situation in which the motor vehicle is in an idle position and a distance between the motor vehicle and a front vehicle increases;
detecting a trajectory of the front vehicle when the presence of the first predetermined driving situation is established;
detecting a presence of a second predetermined driving situation, which chronologically follows the first predetermined driving situation and in which the motor vehicle drives off from the idle position; and
controlling the lateral control of the motor vehicle based on the detected trajectory when the presence of the second predetermined driving situation is established.

12. The method according to claim 11,
wherein detecting the trajectory of the front vehicle takes place until the distance between the motor vehicle and the front vehicle exceeds a threshold value.

13. The method according to claim 11,
wherein controlling the lateral control of the motor vehicle based on the detected trajectory takes place so that the motor vehicle follows the detected trajectory.

14. The method according to claim 11,
wherein controlling the lateral control of the motor vehicle based on the detected trajectory only takes place as long as no lane marking and/or no front vehicle are present in an area of predetermined size in front of the motor vehicle.

15. The method according to claim 14, comprising:
controlling the lateral control of the motor vehicle based on the lane marking and/or the current trajectory of the front vehicle takes place as soon as the lane marking and/or the front vehicle are present in the area of predetermined size in front of the motor vehicle.

16. The method according to claim 11, comprising:
determining a planned route of the motor vehicle; and
comparing the planned route of the motor vehicle to the detected trajectory,
wherein controlling the lateral control of the motor vehicle based on the detected trajectory only takes place when the comparison has a result that the planned route of the motor vehicle and the detected trajectory correspond.

17. The method according to claim 11,
wherein the detected trajectory comprises position information with time information of the front vehicle.

18. A non-transitory computer-readable medium comprising commands, which, upon execution of the commands by a computer, cause the computer to carry out a method comprising:
establishing a presence of a first predetermined driving situation in which a motor vehicle is in an idle position and a distance between the motor vehicle and a front vehicle increases;
detecting a trajectory of the front vehicle when the presence of the first predetermined driving situation is established;
detecting a presence of a second predetermined driving situation, which chronologically follows the first predetermined driving situation and in which the motor vehicle drives off from the idle position; and
controlling a lateral control of the motor vehicle based on the detected trajectory when the presence of the second predetermined driving situation is established.

19. The non-transitory computer-readable medium according to claim 18,
wherein detecting the trajectory of the front vehicle takes place until the distance between the motor vehicle and the front vehicle exceeds a threshold value.

20. The non-transitory computer-readable medium according to claim 18,
wherein controlling the lateral control of the motor vehicle based on the detected trajectory takes place so that the motor vehicle follows the detected trajectory.

21. The non-transitory computer-readable medium according to claim 18,
wherein controlling the lateral control of the motor vehicle based on the detected trajectory only takes place as long as no lane marking and/or no front vehicle are present in an area of predetermined size in front of the motor vehicle.

22. The non-transitory computer-readable medium according to claim 21, wherein the commands, when executed by the computer, cause the computer to execute the method comprising:
controlling the lateral control of the motor vehicle based on the lane marking and/or the current trajectory of the front vehicle takes place as soon as the lane marking and/or the front vehicle are present in the area of predetermined size in front of the motor vehicle.

23. The non-transitory computer-readable medium according to claim 18, wherein the commands, when executed by the computer, cause the computer to execute the method comprising:
determining a planned route of the motor vehicle; and
comparing the planned route of the motor vehicle to the detected trajectory,
wherein controlling the lateral control of the motor vehicle based on the detected trajectory only takes place when the comparison has a result that the planned route of the motor vehicle and the detected trajectory correspond.

24. A data processing device for a motor vehicle, wherein the data processing device is configured to:
establish a presence of a first predetermined driving situation in which the motor vehicle is in an idle position and a distance between the motor vehicle and a front vehicle increases;
detect a trajectory of the front vehicle when the presence of the first predetermined driving situation is established;
detect a presence of a second predetermined driving situation, which chronologically follows the first predetermined driving situation and in which the motor vehicle drives off from the idle position; and
control a lateral control of the motor vehicle based on the detected trajectory when the presence of the second predetermined driving situation is established.

25. The data processing device according to claim 24, wherein the data processing device is configured to:
detect the trajectory of the front vehicle until the distance between the motor vehicle and the front vehicle exceeds a threshold value.

26. The data processing device according to claim 24, wherein the data processing device is configured to:
control the lateral control of the motor vehicle based on the detected trajectory so that the motor vehicle follows the detected trajectory.

27. The data processing device according to claim 24, wherein the data processing device is configured to:
control the lateral control of the motor vehicle based on the detected trajectory only as long as no lane marking and/or no front vehicle are present in an area of predetermined size in front of the motor vehicle.

28. The data processing device according to claim 27, wherein the data processing device is configured to:
control the lateral control of the motor vehicle based on the lane marking and/or the current trajectory of the front vehicle as soon as the lane marking and/or the front vehicle are present in the area of predetermined size in front of the motor vehicle.

29. The data processing device according to claim 24, wherein the data processing device is configured to:
determine a planned route of the motor vehicle;
compare the planned route of the motor vehicle to the detected trajectory; and
control the lateral control of the motor vehicle based on the detected trajectory only when the comparison has a result that the planned route of the motor vehicle and the detected trajectory correspond.

30. A motor vehicle comprising the data processing device according to claim 24.
